(19) United States
(12) Patent Application Publication
(10) Pub. No.: US 2010/0053467 A1
(43) Pub. Date: Mar. 4, 2010

(54) ROTATION SENSITIVE REMOTE CONTROL USING POLARIZED LIGHT

(76) Inventor: Brian D. Maxson, Riverside, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/547,009

(22) Filed: Aug. 25, 2009

Related U.S. Application Data
(60) Provisional application No. 61/093,336, filed on Aug. 31, 2008.

(51) Int. Cl. H04B 10/00; H04N 5/44

(52) U.S. Cl. 348/734; 398/106; 348/E05.096

(57) ABSTRACT

Systems and methods that facilitate rotation sensitive remote control of televisions and the like using polarized light. The remote control unit and the infrared (IR) signal detection system of the television are preferably sensitive to rotation of the remote control unit about its longitudinal axis. Rotation of the remote control unit in coordination with depression of keys or buttons on the remote control unit enables enhanced and quicker navigation through a list of options presented in a user interface displayed on the television screen such as, for example, to turn up or down the volume with a single motion.

### CROSS-REFERENCE TO RELATED APPLICATION

This application claims priority to provisional application Ser. No. 61/093,336 filed Aug. 31, 2008, which application is fully incorporated herein by reference.

### FIELD

The embodiments described herein relate generally to remote control of televisions and, more particularly, to systems and methods that facilitate rotation sensitive remote control using polarized light.

### BACKGROUND INFORMATION

As the capabilities of televisions and other components have increased, so have the capabilities and complexity of their remote control units. In order to accommodate or control the increasing number of features or capabilities of the television and related input audio-video devices, more and more feature or user interface dedicated buttons or keys have been added to the remote control unit.

On such remote controls, pushbuttons are the least costly type of control to implement. As a result, pushbuttons are often used to operate functions that are not inherently on-off, for example channel-up/channel-down or volume up/down buttons on a TV remote. Such functions, in an earlier technology, would have been implemented with a rotatable dial or knob. These were more intuitive and easier to operate, but were more expensive and less reliable. It is desirable to provide a similar sort of “analog” control mechanism on a digital remote, while avoiding those disadvantages.

### SUMMARY

The embodiments provided herein are directed to rotation sensitive remote control of televisions and the like using polarized light. More particularly, as provided in the embodiments described herein, the television includes a menu-based control system that is navigatable by the user through a graphical user interface wherein the user can quickly and easily navigate using rotation sensitive remote control. In a preferred embodiment, the remote control unit and the infrared (IR) signal detection system of the television are sensitive to rotation of the remote control unit about its longitudinal axis. Rotation of the remote control unit in coordination with depression and release of keys or buttons on the remote control unit enables enhanced and quicker navigation through a list of options presented in a user interface displayed on the television screen, or adjustment of a continuously-variable setting such as, for example, to turn up or down the volume with a single motion. Specifically, to turn down the volume, for example, a user points the remote control unit at the television, holds the volume key, and twists the remote counterclockwise. The user then ceases rotation and/or releases the volume key when the volume has reached the desired level.

In a preferred embodiment, a polarizing filter is placed in front of the television's IR signal detector or receiver, and the remote control includes two IR signal emitting light emitting diodes (LEDs) whose polarization is 90 degrees apart. The preferred embodiment takes advantage of the natural polarization of light emitted from those LEDs and employs a novel variation on conventional IR transmission protocol wherein the two LEDs are separately illuminated according to a pattern that allows the detector to distinguish how much of the total light received was contributed by each of the LEDs. Because the light from each LED is attenuated according to the difference in polarization direction between LED and detector, the detector can then discern the angle at which the remote control is being held, with respect to the detector.

Other systems, methods, features and advantages of the example embodiments will be or will become apparent to one with skill in the art upon examination of the following figures and detailed description.

### BRIEF DESCRIPTION OF THE FIGURES

The details of the example embodiments, including fabrication, structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 is a schematic of a television and control system.

FIG. 2 is a schematic perspective view of a remote control unit.

FIG. 3 is a schematic of the detector and subsequent processing that derives the angle of the remote.

FIG. 4 is a graphical representation of the signal strength of the IR signal emitted from one of the LEDs of the remote control as detected by the detector system as the remote control unit is rotated.

FIG. 5 is a graphical representation of the signal strength of the IR signals emitted from the LEDs of the remote control as detected by the detector system as the remote control unit is rotated.

FIGS. 6A, 6B and 6C is a graphical representation of the signal pulses emitted from the LEDs of the remote control as detected by the detector system with the remote control unit oriented at a 45 degree angle.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

The systems and methods described herein are directed to rotation sensitive remote control of televisions and the like using polarized light. More particularly, as provided in the embodiments described herein, the television includes a menu-based control system that is navigatable by the user through a graphical user interface wherein the user can quickly and easily navigate using rotation sensitive remote control. As discussed in detail below, the remote control unit and the infrared (IR) signal detection system of the television are sensitive to rotation of the remote control unit about its longitudinal axis. Rotation of the remote control unit in coordination with depression of keys or buttons on the remote control unit enables enhanced and quicker navigation through a list of options presented in a user interface displayed on the television screen such as, for example, to turn up or down the volume with a single motion. Specifically, to turn down the volume, for example, a user points the remote control unit at the television, holds the volume key, and twists the remote counterclockwise. The user then releases the volume key when the volume has reached the desired level.

In a preferred embodiment, a polarizing filter is placed in front of the television's IR signal detector or receiver, and the remote control includes two IR signal emitting light emitting diodes (LEDs) whose polarization is 90 degrees apart. The preferred embodiment takes advantage of the natural polarization of light emitted from those LEDs and employs a novel variation on conventional IR transmission protocol wherein the two LEDs are separately illuminated according to a different sequence.

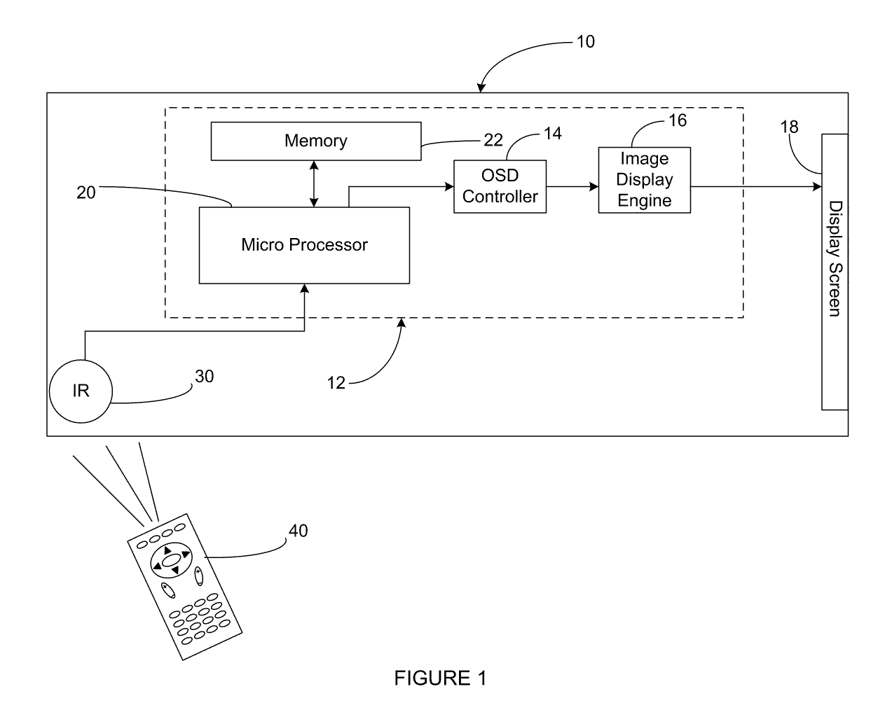

Turning in detail to the figures, FIG. 1 depicts a schematic of an embodiment of a television 10. The television 10 preferably comprises a video display screen 18 and an IR signal receiver or detection system 30 coupled to a control system 12 and adapted to receive, detect and process IR signals received from a remote control unit 40. The control system 12 preferably includes a micro processor 20 and non-volatile memory 22 upon which system software is stored, an on screen display (OSD) controller 14 coupled to the micro processor 20, and an image display engine 16 coupled to the OSD controller 14 and the display screen 18. The system software preferably comprises a set of instructions that are executable on the micro processor 20 to enable the setup, operation and control of the television 10. The system software provides a menu-based control system that is navigatable by the user through a graphical user interface displayed or presented to the user on the television display 18. While on the television layer of the television remote control unit 40, the user can navigate the graphical user interface to setup, operate and control the television 10 and external A-V input devices, such as, e.g., a DVD, a VCR, a cable box, and the like, coupled to the television 10. A detailed discussion of a graphical user interface-based menu control system and its operation is provided in U.S. Published Patent Application No. US 2002-0171624 A1, which is incorporated herein by reference. The '624 application describes the menu-based control system and its operation with regard to the centralized control of audio-video components coupled to a television and controlled using a menu-based control system with a graphical user interface.

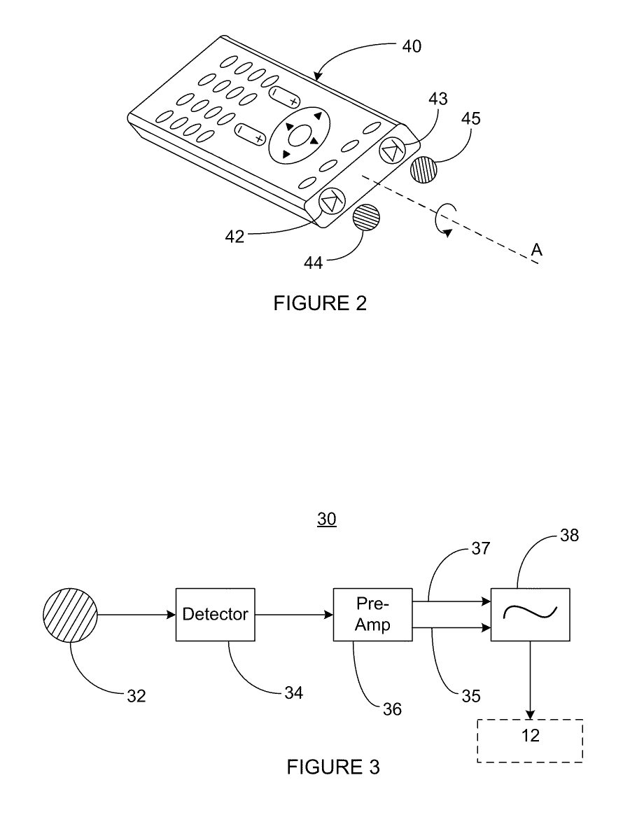

Turning to FIG. 2, a remote control unit 40 is shown to include first and second or right and left LEDs 42 and 43 positioned at the front end of the remote control unit 40. The LEDs 42 and 43 are naturally polarized, and are arranged such that their polarization is 90 degrees apart, illustrated here for conceptual purposes as two polarizing filters 44 and 45 placed in front of the LEDs 42 and 43.

FIG. 3 shows the IR signal detection or receiver system 30 of the television 10 shown in FIG. 1. The system 30 includes a polarizing filter 32 placed in front of an IR detector 34 coupled to a logic unit comprising a preamp 36 which is coupled to a processor 38. The preamp 36 is adapted to sense a pattern of illumination throughout the IR message in predictable intervals during which only the right LED 42 or only the left LED 43 is illuminated. Preamp 36 senses the voltage from detector 34 at these times and produces two digital signals 35 and 37 in response. The quadrature relationship of those two signals 35 and 37 is preferably converted by software executing on the processor 38 into an instantaneous rotation value that can be used by the control system 12 to adjust or change the parameter or feature of the television such as, e.g., the volume or channel, and can be used by the user-interface module of the system software to provide a graphical representation of the action being taken such as, e.g., the turning up or down of the volume or changing of the channel. Alternatively, other logic in the form of ASICs, integrated circuits or a combination thereof with or without software may be configured to covert the quadrature relationship of the two signals 36 and 37.

Since rotations will tend to be continuous, processor 38 might incorporate a Kalman filter or other such processing to the digitized quadrature values. This would permit a relatively good estimate of the angular value while permitting lower-resolution A/D sampling of the light signal from the preamp 36.

In a preferred remote control IR signal transmission protocol, a message is sent in three distinct phases:

| Phase | LED 43 | LED 42 |
|---|---|---|
| Quiescent | off | off |
| 1 | on | on |
| 2 | on | off |
| 3 | off | on |

In one example of a conventional remote control system, a remote message is 160 milliseconds in duration and contains 20 bits, or 8 milliseconds per bit. During that 8 milliseconds, a bit value of 1 is represented by 6 milliseconds “on” and 2 milliseconds “off.” A bit value of zero is represented by 3 milliseconds “on” and 5 milliseconds off. The “on” and “off” state modulate a carrier signal of IR pulses at a rate of, for example, 30 kilohertz. Consequently in this example, the bit value of one is transmitted as 30×6=180 carrier pulses followed by 2 msec of no carrier pulses. A zero is transmitted as 90 carrier pulses followed by 5 msec of no carrier pulses. It becomes easier for the detector to discern the carrier pulses under widely varying IR lighting conditions in the room because it can compare the magnitude of a carrier pulse against the quiescent state between pulses. In the conventional remote, a message like the above is produced repeatedly for the duration that a button is held down. The bits of the message identify the button held as well as other state information of the remote.

In the embodiment provided herein, each bit time is preferably separated into some number of repetitions of the pattern in the table above—either the right LED 42, left LED 43 or both LEDs 42 and 43 are lit or powered on during the first one-third, second one-third or third on-third of this pattern.

To extend the example above, a duration of 1.5 milliseconds is assigned to the repetition of the pattern above. Therefore, each of the 3 phases takes 0.5 milliseconds.

Therefore, to make a bit value of zero:

first, both the right LED 42 and the left LED 43 together make the first 30×0.5=15 carrier pulses.

Next, the left LED 43 only makes the next 15 carrier pulses.

Next, the right LED 42 only makes the next 15 carrier pulses.

Next, both the right LED 42 and the left LED 43 again make the next 15 pulses.

Next, the left LED 43 only makes the next 15 carrier pulses.

Next, the right LED 42 only makes the next 15 carrier pulses. Totally, 3 milliseconds have elapsed.

Then there are no carrier pulses for 5 milliseconds. Totally, 8 milliseconds, or one bit time of the message, have elapsed.

To make a bit value of 1, the pattern is repeated four times instead of two times, for a total of 6 milliseconds or 180 carrier pulses. Then, as before, it is off for 2 milliseconds. Totally, 8 milliseconds or one bit time have elapsed.

During these times, the detector 34 and preamp 36 sample the intensity of the carrier pulses, counting them to determine the phase and from that, learning which LED(s) contributed to it. The detector system 30 knows the phase relationship noted above and can resolve the contribution of light received from the first and second LEDs 42 and 43. The message is sent for the duration a button is held down, ceasing when it is released. Consequently one skilled in the art will recognize that this message protocol identifies both the rotation angle of the remote at any time any button is held down, as well as the identity of the button.

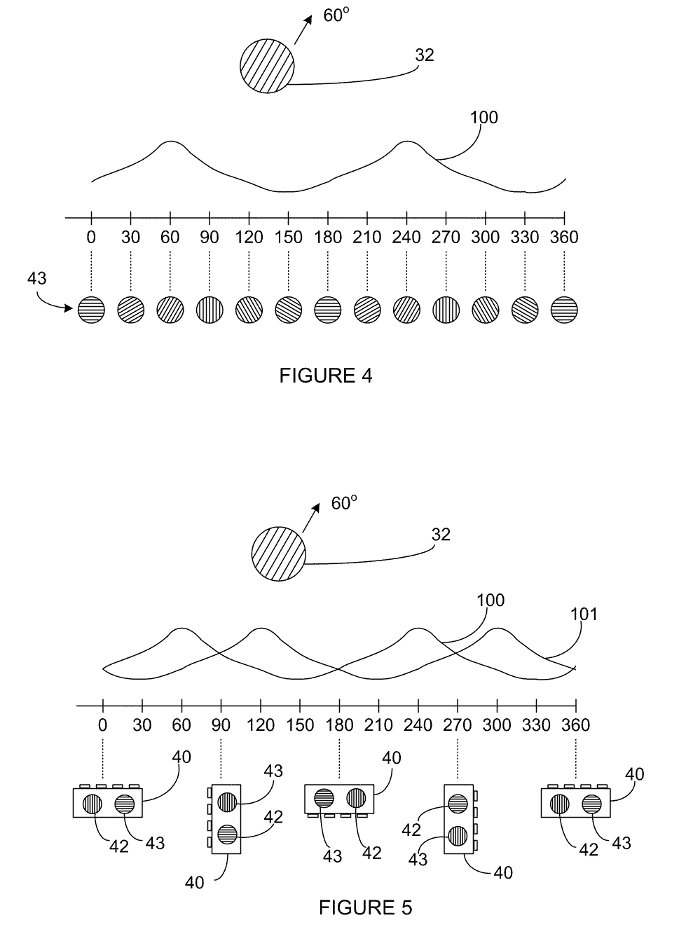

Turning to FIG. 4, a theoretical envelope of the amount of light sensed by the detector system 30 when the second or left LED 43 is lit or powered, depending on the orientation of the remote control unit 40. If the detector system filter 32 is oriented at, for example, sixty degrees (60°), and if the orientation of the natural polarization of the left LED 43 is zero degrees (0°) for purposes of this example, then whenever the remote control unit 40 is at an angle of 60° or 240° the detector 34 should sense the largest amount of light that it receives from the left LED 43 (as indicated by the row of polarizing filters) when the left LED 43 is lit or powered. This relative intensity is shown by line 100. When the remote is rotated at about 150° or 330° degrees, the detector will see the least amount of light from the second LED 43 that it receives when the left LED 43 is lit or powered.

FIG. 5 shows the amount of light received from both the right and left LEDs 42 and 43 superimposed on the same graph. For purposes of this discussion, the natural polarizations of the right and left LEDs 42 and 43 are ninety degrees (90°) and zero degrees (0°), respectively. The relative intensity of LED 43 is shown by line 100 and the relative intensity of LED 42 is shown by line 101. If the detector system 30 can get approximate values of the two LED'S 42 and 43 relative to one another, it becomes possible as described below to derive the current rotation of the remote control unit 40. Note that due to limitations of the human wrist only about 100 degrees (100°) of this range is useful; all 360 degrees (360°) are shown for completeness. Additionally, due to this limitation, the ambiguity of angles 180 degrees (180°) apart is not a problem in practical situations.

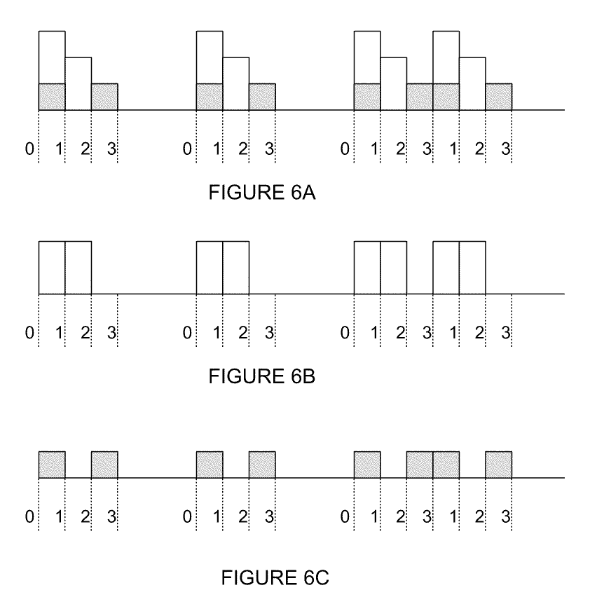

FIGS. 6A, 6B and 6C breaks down the contributions of light seen at the detector 34, taking into account the angle of the remote control relative to the detector's filter 32. FIG. 6A shows the signal seen by the detector 34 when the remote control unit is held at a forty-five degree (45°) angle from its reference position. At this point, most of the polarized light emitted by the left LED 43 will be visible at the detector 34. This is represented by the non-shaded box. Only a small amount of the light of the left LED 42 will be visible at the detector 34, illustrated by the gray-shaded box. During phase 1, the detector sees the sum of the right LED 42 and the left LED 43 and can use this intensity as a reference.

FIG. 6B shows only the contribution of LED 43 to the overall light signal shown in FIG. 6A. During phases 1 and 2, LED 43 is on, and most of its light is visible.

FIG. 6C shows only the contribution of the right LED 42 to the light visible at the detector 34. Its natural polarization is 90 degrees, so if the remote is held at 45 degrees the polarization of its light is nearly crossed with the polarizing filter 32 of the detector system 30. Only a little of its light is visible by the detector 34. Therefore the first LED 42 makes a small contribution to the total light during phase 1 and provides a little light during phase 3.

If the detector 34 uses the amount of light it sees during phase 1 and during the time between carrier pulses as a reference, then it can get an estimate of the relative contribution of the right and left LEDs 42 and 43 during subsequent phases, and thus derive the current rotation or angular orientation of the remote control unit 32 relative to its longitudinal axis. This information is then used by the control system 12 to change or adjust a feature or parameter of the television such as, e.g., turn the volume up or down or change the channel, or move through selection within the graphical user interface. This information is also used by the UI software module to graphically show the user navigation through the UI displayed on the screen 18 and adjustments of features or parameters of the system.

As one skilled in the art would readily recognize, this process can be used for the automatic setup of audio levels and delays in surround systems with televisions that serve the AVR function and include an integral surround sound decoder and either a sound projector, a power amplifier or wireless transmitters for discrete external speakers.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions shown in the process flow diagrams described herein is merely illustrative, unless otherwise stated, and the invention can be performed using different or additional process actions, or a different combination or ordering of process actions. As another example, each feature of one embodiment can be mixed and matched with other features shown in other embodiments. Features and processes known to those of ordinary skill may similarly be incorporated as desired. Additionally and obviously, features may be added or subtracted as desired. Accordingly, the invention is not to be restricted except in light of the attached claims and their equivalents.

What is claimed is:

1. A rotation sensitive remote control system comprising
a remote control unit comprising
a plurality of infrared LEDs with differing polarizations, and
a plurality of keys that can be held down to cause the plurality of LEDs to emit IR signals as the remote is rotated,
an IR rotation sensitive detector system comprising
an IR detector,
a polarizing filter positioned in front of the IR detector, and
a logic unit capable of sensing the patterns of illumination of the plurality of LEDs on the remote control unit, determining the contribution made by each of the plurality of LEDs, and deriving a relative angle at which the remote control is positioned.

2. The system of claim 1 wherein the logic unit includes a preamp coupled to the IR detector and a processor coupled to the preamp.

3. The system of claim 1 wherein the remote control unit is adapted to transmitted IR signals comprised of patterns of illumination having a sequence of unique subsets of the plurality of LEDs from which the contribution of each of the plurality of LEDs can be extracted.

4. A television system comprising rotation sensitive remote control system comprising
a display screen,
an on screen display controller,
a remote control unit comprising
a plurality of infrared LEDs whose polarizations differ one from another, and
a plurality of keys that can be held down to cause the plurality of LEDs to emit IR signals as the remote is rotated, and
a control system coupled to the on screen display controller, the control system including an IR rotation sensitive detector system comprising
an IR detector,
a polarizing filter positioned in front of the IR detector, and
a logic unit capable of sensing the patterns of illumination of the plurality of LEDs on the remote control unit, determining the contribution made by each of the plurality of LEDs, and deriving a relative angle at which the remote control is positioned,
wherein the control system includes a graphical user interface system displayable on the screen.

5. The system of claim 4 wherein the logic unit includes a preamp coupled to the IR detector and a processor coupled to the preamp.

6. The system of claim 4 wherein the remote control unit is adapted to transmitted IR signals comprised of patterns of illumination having a sequence of unique subsets of the plurality of LEDs from which the contribution of each of the plurality of LEDs can be extracted.

7. The system of claim 4 wherein the control system is adapted to use the derived position of the remote control unit to derive and display a user's navigation, selection or adjustments within the graphical user interface.

8. A process of controlling a television comprising the steps of
sensing the patterns of illumination of a plurality of LEDs on a remote control unit,
determining the contribution made by each of the plurality of LEDs, and
deriving a relative angle at which the remote control is positioned.

9. The process of claim 8 further comprising the steps of
transmitting IR signals comprised of patterns of illumination having a sequence of unique subsets corresponding to the plurality of LEDs from which the contribution of each of the plurality of LEDs can be extracted.

10. The process of claim 9 further comprising the steps of
filtering the IR signals sensed by an IR detector with a polarized filter.

11. The process of claim 10 further comprising the steps of
converting a voltage output by the detector into a plurality of signals corresponding to the plurality of LEDs.

12. The process of claim 11 further comprising the steps of
converting a quadrature relationship of the plurality of signals into a rotation value.

13. The process of claim 12 further comprising the steps of
navigating a user interface as a function of the rotation value.
